(19) United States
(12) Patent Application Publication
(10) Pub. No.: US 2001/0055981 A1
(43) Pub. Date: Dec. 27, 2001

(54) Portable communication apparatus

(76) Inventors: Shin Iima, Tokyo (JP); Hirofumi Kanemaki, Kanagawa (JP)

Correspondence Address: William S. Frommer, Esq., FROMMER LAWRENCE & HAUG LLP, 745 Fifthe Avenue, New York, NY, 10151, US

(21) Appl. No.: 09/836,051

(22) Filed: Apr. 17, 2001

(30) Foreign Application Priority Data
Apr. 19, 2000 (JP) 2000-123706

(51) Int. Cl. H04B 1/06

(52) U.S. Cl. 455/556; 455/344

(57) ABSTRACT

A portable communication apparatus comprising a communication means for making a call and receiving an audio signal distributed from a server by a digital wireless system, a recording means for recording the audio signal received by the communication means, a reproduction means for reproducing the audio signal read from the recording means, and an output means for output in accordance with the reproduced audio signal.

### BACKGROUND OF THE INVENTION

1. Field of the Invention

The present invention relates to a portable communication apparatus having a download function and a reproduction function for an audio signal from a server in addition to a call function.

2. Description of the Related Art

A portable telephone of the related art is designed mainly for voice calls, so need only have a monaural type speaker or earphone.

Further, such portable telephones include ones which can output various melodies indicating an incoming call, but these are meant only to inform the user of an incoming call, therefore there are not many requests for improving the sound quality.

In recent years, however, services have begun offering downloading of audio signals of music from a music distribution server through a network to a computer or other terminal.

When a user wishes to reproduce an audio signal distributed by such a service by a portable player, the user has to perform the following procedure.

First, the user connects the computer to a portable telephone or a home telephone line, accesses the music distribution server through the network, and downloads the audio signal to the hard disk of the computer. Next, the user records the downloaded audio signal from the hard disk of the computer to a recording medium able to be used by the portable player, loads the recording medium in the portable player, and reproduces the audio signal.

Because this procedure takes much trouble and is inconvenient, there are demands to enable the reproduction of an audio signal distributed by a music distribution server by a portable apparatus more easily.

### SUMMARY OF THE INVENTION

An object of the present invention is to provide a portable communication apparatus able to play back music distributed by a music distribution server easily in addition to making a voice call.

According to a first aspect of the present invention, there is provided a portable communication apparatus comprising a communication means for making a call and receiving an audio signal distributed from a server by a digital wireless system, a recording means for recording the audio signal received by the communication means, a reproduction means for reproducing the audio signal read from the recording means, and an output means for output in accordance with the reproduced audio signal.

The operation of the portable communication apparatus of the first aspect of the invention is as follows.

First, in the portable communication apparatus of the present invention, a call is made by the communication means by a digital wireless system in the same way as a portable telephone of the related art.

Further, in the portable communication apparatus of the present invention, when downloading an audio signal from a server, the server connected to the Internet and so on is accessed, for example, in response to an instruction by the user through the communication means by the digital wireless system.

Next, the communication means receives the audio signal from the server, and the received audio signal is recorded in the recording means.

Next, when the user instructs reproduction, the audio signal is read from the recording means and reproduced by the reproduction means.

Then, output in response to the audio signal reproduced by the reproduction means is carried out by the output means.

Further, preferably, the reproduction means is able to perform stereo reproduction of the audio signal read from the recording means, and the output means is able to perform stereo output in response to the audio signal.

Further, preferably, the recording means is inserted in the portable communication apparatus in a removable manner.

Still more preferably, the reproduction means is able to perform stereo reproduction of an audio signal read from the recording means, and the output means is able to output the stereo reproduced audio signal from a connection terminal to which a stereo headphone may be connected.

According to a second aspect of the present invention, there is provided a portable communication apparatus comprising a communication means for making a call and receiving a streaming file distributed from a server by a digital wireless system, a recording means for recording audio data in a streaming file received by the communication means, a reproduction means for restoring an audio signal from the audio data read from the recording means and reproducing the restored audio signal, and an output means for output in accordance with the reproduced audio signal.

The operation of the portable communication apparatus of the second aspect of the invention is as follows.

The streaming file distributed from the server is received by the communication means by a digital wireless system.

Then, the audio data of the received streaming file is recorded in the recording means.

Next, the audio data is restored from the audio signal read from the recording means by the reproduction means.

Next, output is performed in accordance with the reproduced audio signal by the output means.

### BRIEF DESCRIPTION OF THE DRAWINGS

These and other objects and features of the present invention will become clearer from the following description of the preferred embodiments given with reference to the accompanying drawings, in which:

FIG. 1 is a schematic view of the appearance of a portable telephone of an embodiment of the present invention;

FIG. 2 is a view of the configuration of the portable telephone shown in FIG. 1;

FIG. 3 is a view for explaining a case for downloading an audio signal from a music distribution server using the portable telephone shown in FIG. 1;

FIG. 4 is a flow chart for explaining an example of operation of a case for downloading an audio signal of music from a music distribution server on the Internet and reproducing the downloaded signal in the portable telephone shown in FIG. 1; and

FIG. 5 is a flow chart for explaining an example of operation of a case for streaming reproduction of a streaming file received from a music distribution server in the portable telephone shown in FIG. 1.

### DESCRIPTION OF THE PREFERRED EMBODIMENTS

Preferred embodiments will be described with reference to the accompanying drawings.

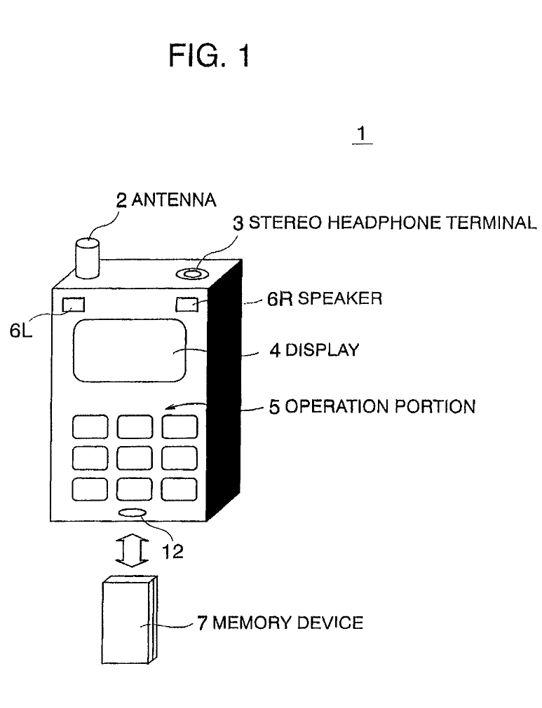

FIG. 1 is a schematic view of the appearance of the portable telephone 1 of the present embodiment.

As shown in FIG. 1, the portable telephone 1 comprises an antenna 2, a stereo headphone terminal 3, a display 4, a control panel 5, and stereo speakers 6R and 6L on the exterior surface.

Further, the portable telephone 1 is able to be provided with a memory 7 such as a semiconductor memory in a removable state.

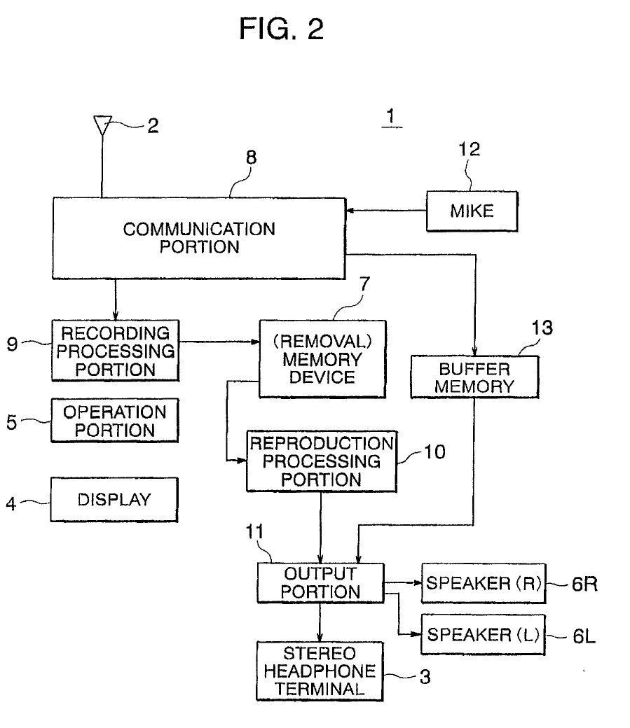

FIG. 2 is a view of the configuration of the portable telephone 1.

As shown in FIG. 2, the portable telephone 1 comprises, for example, the antenna 2, the stereo headphone terminal 3, the display 4, the control panel 5, the speakers 6R and 6L, a memory 7, a communication portion 8, a reproduction processor 10, an output 11, a microphone 12, and a buffer memory 13.

The portable telephone 1, in addition to functioning as a terminal for a cellular wireless call system, for example, has functions of downloading and storing (recording) an audio signal of music and so on distributed by a music distribution server 21 connected to a network 20 such as the Internet and for reproducing and outputting the audio signal in a stereo manner.

The antenna 2 receives a communication signal from bases of the cellular network and outputs the received communication signal to the communication portion 8.

Further, the antenna 2 transmits a communication signal from the communication portion 8 to a base.

The stereo headphone terminal 3 can have stereo headphones detachably connected to it and outputs the audio signal input from the output 11 to the stereo headphones.

The display 4 displays the operation information of the control panel 5 by the user, information based on the communication signal received by the communication portion 8 through the antenna 2, and so on and is for example a liquid crystal display (LCD).

The control panel 5 is for example a keyboard or a plurality of control keys. From this control panel 5, a telephone number or an address of the communication partner, instruction for communication, and so on are input.

The speaker 6R outputs sound in response to the R (Right) audio signal of the stereo audio signal input from the output 11.

The speaker 6L outputs sound in response to the L (Left) audio signal of the stereo audio signal input from the output 11.

The memory 7 is for example a semiconductor memory able to be inserted into or removed from the portable telephone 1.

The memory 7 can be used as a memory of an audio recording apparatus other than the portable telephone 1.

The communication portion 8 has, for example, a wireless management function, movement management function, and call control function.

The wireless management function is a function for selecting the zone of the cellular system and setting up, maintaining, switching, and disconnecting a wireless line.

The movement management function is a function for supporting the mobility of the portable telephone 1 and registering the position of and certifying the portable telephone 1.

The call management function is a function for sending a call (transmitting), receiving a call (receiving), handing over a call, and disconnecting a call.

The communication portion 8 outputs an audio signal indicating the voice of the communication partner in the communication signal input from the antenna 2 to the output 11 during the communication.

Further, the communication portion 8 outputs a communication signal including an audio signal input from a microphone 12 to the antenna 2 during the communication.

Further, if a digital audio signal downloaded from the Internet is input to the communication portion 8 from the antenna 2, the communication portion 8 outputs the audio signal to the recording processor 9.

In this embodiment, the case of downloading a stereo type audio signal will be explained.

Note that, the communication portion 9 may also output the audio signal to the reproduction processor 10.

The recording processor 9 writes the audio signal input from the communication portion 8 at a predetermined address of the memory 7.

The reproduction processor 10 reads the audio signal from a designated address of the memory 7 in response to a control signal from the control panel 5, reproduces it to obtain the audio signal, and outputs it to the output 11.

The reproduction processor 10 can perform stereo reproduction. If the audio signal read from the memory 7 is a stereo audio signal, the reproduction processor 10 outputs the R audio signal and the L audio signal to the output 11.

Further, when it does not store the received streaming file in the memory 7 but directly reproduces it via the buffer memory 13 as a stream, the reproduction processor 10 successively reads the data of the streaming file from the buffer memory 13 using the reproduction software, restores the audio signal from the read data, and reproduces it.

The output 11 outputs the R and L audio signals to the stereo headphone terminal 3 when the stereo headphones are connected to the stereo headphone terminal 3.

On the other hand, when the stereo headphones are not connected to the stereo headphone terminal 3, the output 11 outputs the R audio signal to the speaker 6R and outputs the L audio signal to the speaker 6L.

Examples of the operation of the portable telephone 1 will be described below.

FIRST EXAMPLE OF OPERATION

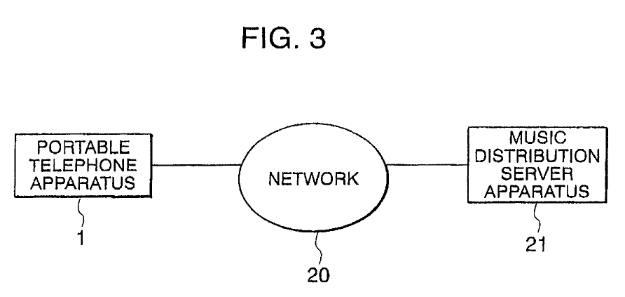

In this example of operation, the operation of the portable telephone 1 will be explained when downloading an audio signal of music from the music distribution server 21 on the Internet shown in FIG. 3 and reproduces it.

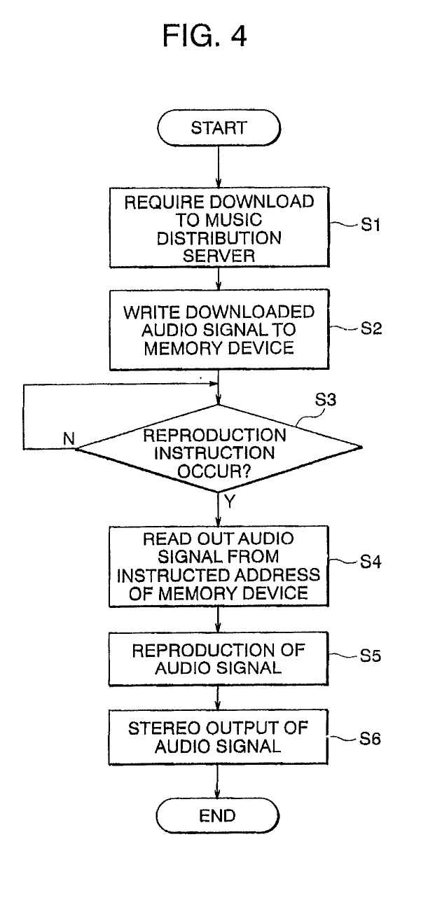

FIG. 4 is a flow chart for explaining the operation.

Step S1

A user operates the control panel 5 to input address information of the music distribution server 21 on the Internet and an access instruction. By this, the music distribution server 21 on the Internet is accessed by the communication portion 8 and the antenna 2.

Then, for example, information of a service screen provided by the music distribution server 21 is received through the antenna 2 by the communication portion 8. A screen in response to this is displayed on the display 4.

Next, the user views the screen of the display 4 and operates the control panel 5 to input the information of the music for which download is required.

Step S2

The communication portion 8 downloads (receives) the corresponding audio signal from the music distribution server 21 through the antenna 2.

The downloaded audio signal is written at a predetermined address of the memory 7 under the control of the recording processor 9.

Step S3

If an instruction for reproduction of the downloaded audio signal is output in accordance with the operation of the control panel 5 by the user, the processing in the step S4 is carried out.

Step S4

The downloaded audio signal is read from a certain address of the memory 7 by the reproduction processor 10.

Step S5

The reproduction processor 10 performs processing for reproduction of the audio signal read at step S4.

Step S6

The R and L audio signals reproduced at step S5 are output through the stereo headphone terminal 3 to the stereo headphones by the output 11.

Alternatively, the R audio signal reproduced at step S5 is output to the speaker 6R and the L audio signal is output to the speaker 6L by the output 11.

### SECOND EXAMPLE OF OPERATION

In this example of operation, the operation of the portable telephone 1 will be explained when inserting a memory 7 in which an audio signal is recorded by another audio recording apparatus in the portable telephone 1.

Namely, the memory 7 is removed from the portable telephone 1 and inserted in the other audio recording apparatus to write an audio signal in the memory 7.

Next, the memory 7 is removed from the audio recording apparatus and is inserted in the portable telephone 1.

Next, in response of operation of the control panel 5 by the user, an instruction for reproduction of the audio signal recorded at the address in the memory 7 is output.

In accordance with this, the audio signal is read from the address of the memory 7 and reproduced out.

Next, the reproduced R and L audio signals are output through the stereo headphone terminal 3 to the stereo headphones by the output 11.

Alternatively, the reproduced R audio signal is output to the speaker 6R and the L audio signal is output to the speaker 6L by the output 11.

### THIRD EXAMPLE OF OPERATION

In this example of operation, the operation of the portable telephone 1 will be explained when performing streaming reproduction of a streaming file received from the music distribution server.

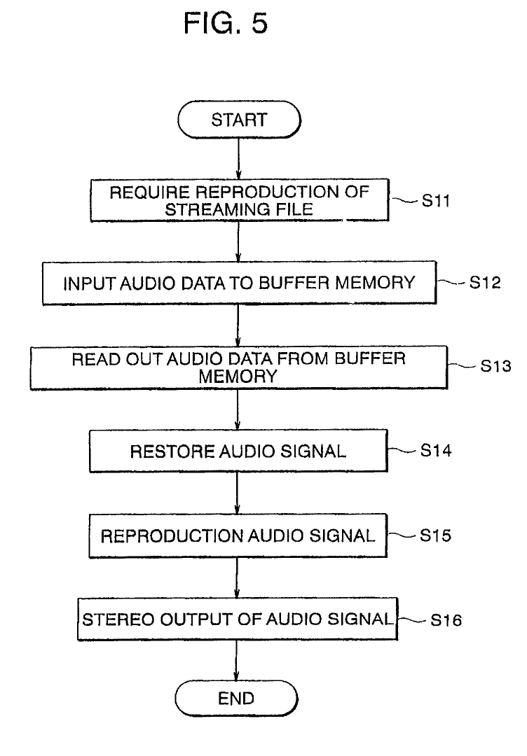

FIG. 5 is a flow chart of the processing.

Step S11

A user operates the control panel 5 to input address information of the music distribution server 21 on the Internet and an access instruction. Due to this, the music distribution server 21 on the Internet is accessed by the communication portion 8 and the antenna 2.

Then, a request for reproduction of the streaming file is output from the portable telephone 1 to the music distribution server 21.

Step S12

The audio data of the streaming file received by the communication portion 8 from the music distribution server 21 is stored in the buffer memory 13.

Step S13

The audio data of the streaming file is successively read using the reproduction software from the buffer memory 13 by the reproduction processor 10.

Step S14

The reproduction processor 10 restores the audio signal from the audio data read at step S13.

Step S15

The reproduction processor 10 reproduces the audio signal restored at step S14.

Step S16

The R and L audio signals reproduced at step S15 are output through the stereo headphone terminal 3 to the stereo headphones by the output 11.

Alternatively, the R audio signal reproduced at step S5 is output to the speaker 6R and the L audio signal is output to the speaker 6L by the output 11.

As explained above, according to the portable telephone 1, stereo output may be obtained by reproducing the audio signal downloaded from the music distribution server 21 through a network 20.

Accordingly to the portable telephone 1, the user can more easily enjoy desired music using a portable apparatus by a high quality stereo audio output on demand without using a personal computer.

Further, according to the portable telephone 1, since the memory 7 can be inserted and removed, the user can enjoy even music recorded in the memory 7 using any audio recording apparatus at the home etc. by a high quality stereo audio output by just inserting the memory 7 in the portable telephone 1.

Note that the present invention is not limited to the above embodiments and includes modifications within the scope of the claims.

For example, in the above embodiment, the explanation was given with reference to a memory 7 able to be inserted into or removed from a portable telephone 1, but the memory 7 may also be fixed to the portable telephone 1 so as not to be removed easily.

Summarizing the effects of the Invention, as described above, according to the portable communication apparatus of the present invention, the recording, reproduction, and output of an audio signal received from the server become possible in addition to a call.

Further, according to the portable communication apparatus of the present invention, stereo reproduction of an audio signal becomes possible, so music can be output with a high quality in accordance with the audio signal.

Further, according to the portable communication apparatus of the present invention, the memory is made removable, so an audio signal recorded using another audio recording apparatus can be reproduced and output.

Further, according to the portable communication apparatus of the present invention, it becomes possible to receive a streaming file distributed from a server and carry out streaming reproduction.

What is claimed is:

1. A portable communication apparatus, comprising:
a communication means for making a call and receiving an audio signal distributed from a server by a digital wireless system,
a recording means for recording the audio signal received by the communication means,
a reproduction means for reproducing the audio signal read from the recording means, and
an output means for output in accordance with the reproduced audio signal.

2. A portable communication apparatus as set forth in the claim 1, wherein
the reproduction means is able to perform stereo reproduction of the audio signal read from the recording means, and
the output means performs stereo output in response to the audio signal.

3. A portable communication apparatus as set forth in the claim 1, wherein the recording means is inserted in the portable communication apparatus in a removable manner.

4. A portable communication apparatus as set forth in the claim 1, wherein
the reproduction means is able to perform stereo reproduction of an audio signal read from the recording means, and
the output means outputs the stereo reproduced audio signal from a connection terminal to which a stereo headphone may be connected.

5. A portable communication apparatus comprising:
a communication means for making a call and receiving a streaming file distributed from a server by a digital wireless system,
a recording means for recording audio data in a streaming file received by the communication means,
a reproduction means for restoring an audio signal from the audio data read from the recording means and reproducing the restored audio signal, and
an output means for output in accordance with the reproduced audio signal.
